(19) United States
(12) Patent Application Publication
(10) Pub. No.: US 2006/0272159 A1
(43) Pub. Date: Dec. 7, 2006

(54) Apparatus and method for cutting items and method of forming the same

(76) Inventors: Richard Howard Rubin, Fairfield, NJ (US); Bruce Simon, Montclair, NJ (US)

Correspondence Address: KENYON & KENYON LLP, 1500 K STREET N.W., SUITE 700, WASHINGTON, DC, 20005, US

(21) Appl. No.: 11/444,361

(22) Filed: Jun. 1, 2006

Related U.S. Application Data
(60) Provisional application No. 60/686,938, filed on Jun. 3, 2005.

(51) Int. Cl. B26B 3/06

(52) U.S. Cl. 30/162

(57) ABSTRACT

Embodiments of the present invention provide for an apparatus and methods for cutting of items. The cutting apparatus may include a first housing including a cutting blade and a second housing spaced apart from the first housing. The second housing may include a material support, the material support including a groove. The cutting apparatus is operable to move from an open position where the cutting blade is spaced apart from the material support to a closed position where the cutting blade engages in the groove of the material support.

### CROSS REFERENCE TO RELATED APPLICATION

This application claims priority from provisional application Ser. No. 60/686,938, filed on Jun. 3, 2005, which is incorporated by reference herein in it's entirety.

### TECHNICAL BACKGROUND

The present invention relates to an apparatus for cutting of items and a method of forming the cutting apparatus.

### BACKGROUND INFORMATION

Various types of items are difficult to open without the use of some sort of cutting device such as scissors, a knife, etc. However, these cutting devices are very difficult or even dangerous to use to cut some types of materials. For example, the consumer industry more so than any other has embraced a plastic packaging called a clamshell for packaging items which is ridged and impossible to open without a cutting implement. A consumer typically uses a pair of scissors, razor blade, knife or other sharp implement to try and cut open the plastic clam shell or any other package that is sealed. Numerous accidents have occurred trying to do this. Either your hand holding the scissor goes across the sharp edge of the material, or the knife slips into your hand holding the package, resulting in many cuts and bruises.

Many other types of packages such as cereal bags, snack bags, special postal envelopes and lawn chemicals to name a few examples are also very difficult to open without spilling them as the consumer must struggle to pull them apart without ripping and destroying the package.

Accordingly, what is needed is a cutting apparatus that can be safely used to open or cut items, which are difficult to cut or open. A hand held cutting apparatus that could cut or open such items would be particularly useful.

### SUMMARY OF THE INVENTION

Embodiments of the present invention provide for an apparatus and methods for cutting of items. The cutting apparatus may include a first housing including a cutting blade and a second housing spaced apart from the first housing. The second housing may include a material support, the material support including a groove. The cutting apparatus is operable to move from an open position where the cutting blade is spaced apart from the material support to a closed position where the cutting blade engages in the groove of the material support.

### BRIEF DESCRIPTION OF THE DRAWINGS

FIG. 1 is a diagram of a front view of an embodiment of the present invention.

FIG. 2 is a diagram of a front view of an embodiment of the present invention.

FIG. 3 is a diagram of a side view of an embodiment of the present invention.

FIG. 4 is a diagram of a back view of an embodiment of the present invention.

FIG. 5 is a diagram of a internal view of a top housing of an embodiment of the present invention.

FIG. 6 is a diagram of a internal view of a bottom housing of an embodiment of the present invention.

FIG. 7 is a diagram of a internal view of a top housing of an embodiment of the present invention.

FIG. 8 is a diagram illustrating the cutting apparatus positioned to cut a package or material in accordance with an embodiment of the present invention.

### DETAILED DESCRIPTION

Embodiments of the present invention provide for an apparatus and methods for cutting of items. The present apparatus and method may effectively cut items that are difficult to cut or open. The present invention is particularly useful when used to cut or open items that are difficult to cut or open using a traditional cutting device, such as scissors or a knife, as further explained below.

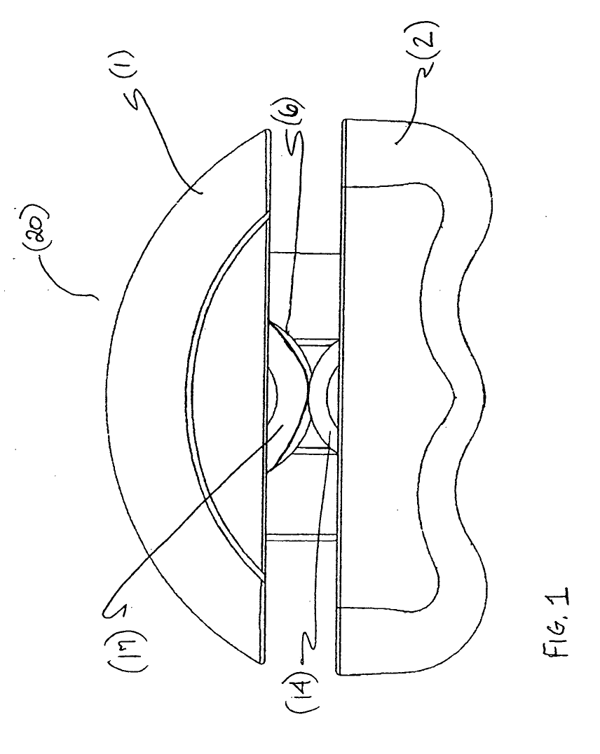

The cutting apparatus 20 of the present invention is illustrated in a closed position in FIG. 1. As shown, the cutting apparatus includes a top housing 1 and a bottom housing 2. The top and bottom housings 1, 2 may be formed in a size and shape so as to be easily held in one hand. The material used for the top and bottom housings 1, 2 could be plastic or any other suitable material that is strong enough to handle the stress and forces while cutting. In this example the housings are plastic injection molded.

The cutting apparatus includes a cutting blade 6, which may be attached to the top housing 1, and a material support 14, which may be attached to the bottom housing 2. The top and bottom housings 1, 2 are connected together. The cutting apparatus 20 may include an optional blade guard 17, although the blade guard 17 is not a necessary component of the invention.

As further explained below, the cutting apparatus may be formed so as to have two positions, a closed position where the cutting blade 6 is engaged with the material support 14, and an open position, where the cutting blade is spaced apart from the material support 14. In use, a material to be cut can be placed between the cutting blade 6 and the material support 14 when the cutting apparatus 20 is in the open position. Then, the cutting apparatus 20 can be moved to the closed position by a user, so that the cutting blade 6 will engage and puncture the material to be cut.

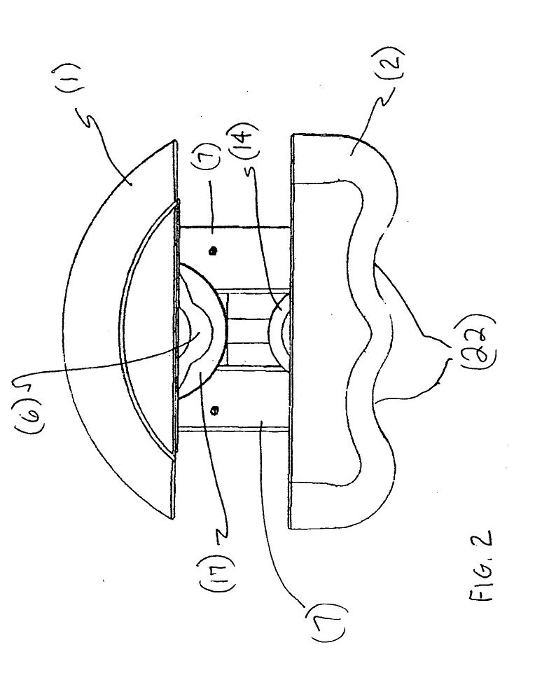

FIG. 2 illustrates a side view of the cutting apparatus 20 in an open position. In the open position, the cutting blade 6 is spaced apart from the material support 14. As further explained below, the cutting apparatus may be changed from the open position illustrated in FIG. 2 to the closed position illustrated in FIG. 1 by the user pressing on a top of the top housing 1 and a bottom of the bottom housing 2.

For example, a user may hold the cutting apparatus in the user's hand, typically with the user's thumb on the top of the top housing 1, and other fingers on the bottom of the bottom housing 2, and press the housing together to close the cutting apparatus 20 to the closed position. The cutting apparatus is designed so that it may be closed with the use of only one hand. The bottom housing may include grooves 22 for positioning of the user's fingers. The grooves 22 are used to help the user adequately hold and secure the cutting apparatus 20. The grooves 22 could be on either or both of the top and bottom housings.

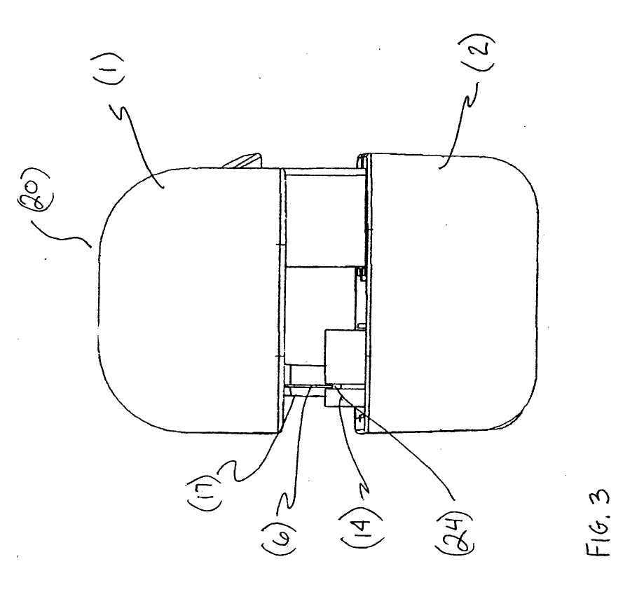

FIG. 3 illustrates a side view of the cutting apparatus 20 in a closed position. In the closed position, the cutting blade 6 engages with the material support 14. The material support 14 may include a groove 24, which the cutting blade 6 engages with in the closed position. In particular, the cutting blade 6 may fit into the groove 24 when the cutting apparatus is in the closed position. The material support 14 may be formed in the shape of a wheel, and may rotate. The cutting blade 6 may also be formed in the shape of a wheel and rotate. The top housing 1 also includes two connecting portions 7, which may be in the shape of hollow tubes. The connecting portions 7 connect with and engage elements of the bottom housing 2, and can be any shape as long as they can encompass the protrusion and shape of the bottom housing 2 that extends upwards. These connecting portions serve as guides for the two housings to be joined and slide together and apart, as further described below.

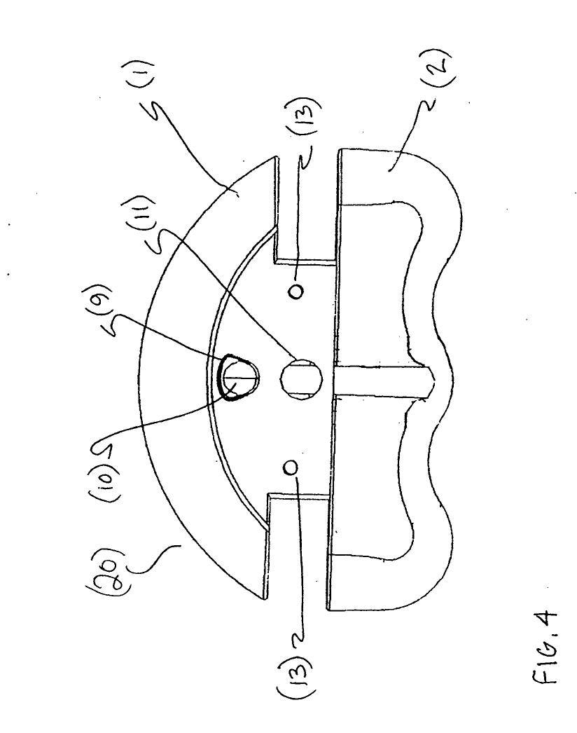

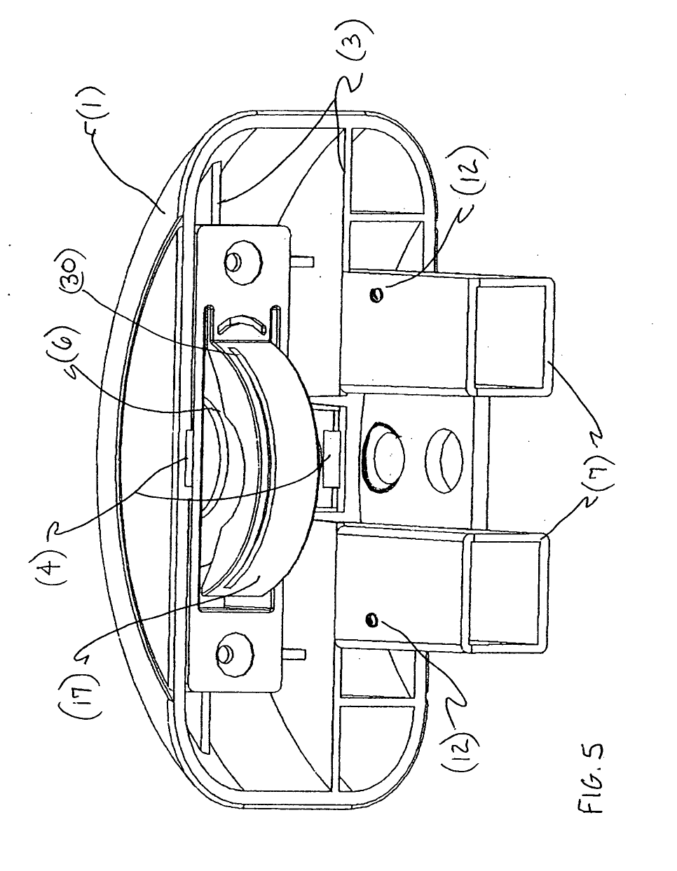

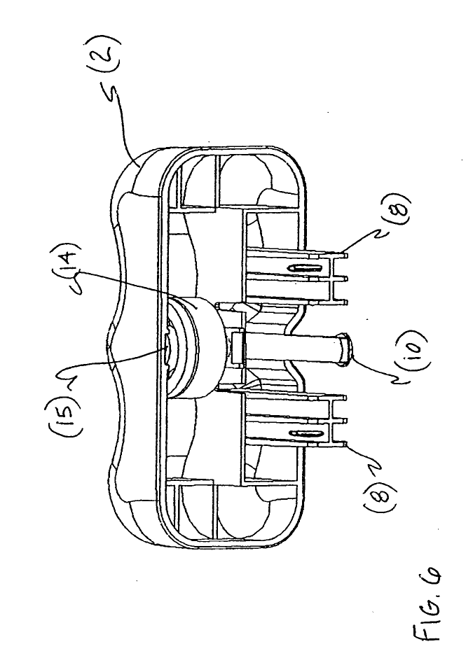

FIG. 4 illustrates a back view of the cutting apparatus 20. Further details are now described with reference to FIGS. 4-7. Protruding columns 8 are formed as part of the bottom housing, and engage with the connecting potions 7. The connecting portions provide a guide for aligning the top housing 1 with the bottom housing 2. These guides which are shown as two can be either more or less in number as long as they provide the guidance and strength to the two housings while the cutting apparatus is in the open and closed positions. In FIG. 4 and 5, the larger hole 9 on the top housing 1 is for a spring catch button 10 that is attached to the bottom housing 2 to protrude thru when the apparatus is closed and to lock it in the closed position. A smaller hole 11 is for the spring catch button 10 to sit in when the cutting apparatus 20 is in the open position as in FIG. 2. The tiny holes 12 in each connecting portion 7 on the top housing 1 accept plastic snap pins 13 that are pushed thru the top housing tubes, thru the slots in the bottom housing columns and out thru the other end of the tubes. These pins are put in place once the two housings 1, 2 are assembled and do not allow the housings 1, 2 to be disassembled after the pins are pushed thru.

The bottom housing 2 holds the material support wheel 14 that has the groove in the middle of it to accept the cutting wheel edge to a certain depth and angle. This material support wheel 14 rotates freely upon a shaft 15 inserted through its center and may be supported by ribs in the bottom housing 2. This shaft is retained inside the housing by a snap ring, cotter pin or any other shaft retainer (not shown). At the end of the center post is the spring catch button 10 for holding the two housings closed while cutting takes place. Here it is shown as one spring catch in between the two connecting portions 7, whereas there could be two spring catch buttons, one in each connecting portion. As shown in FIG. 3, when the two housing 1,2 are pushed together, the cutting wheel 6 is engaged with the material support wheel 14 and shear has taken place, the spring catch button 10 will snap into an opening 9 in the top housing 2. When cutting is complete the spring catch button 10 may be pushed to release the two housings and they can be spread apart. Springs 16 inside the tubes help separate the two housings after the spring catch button 10 has been pressed.

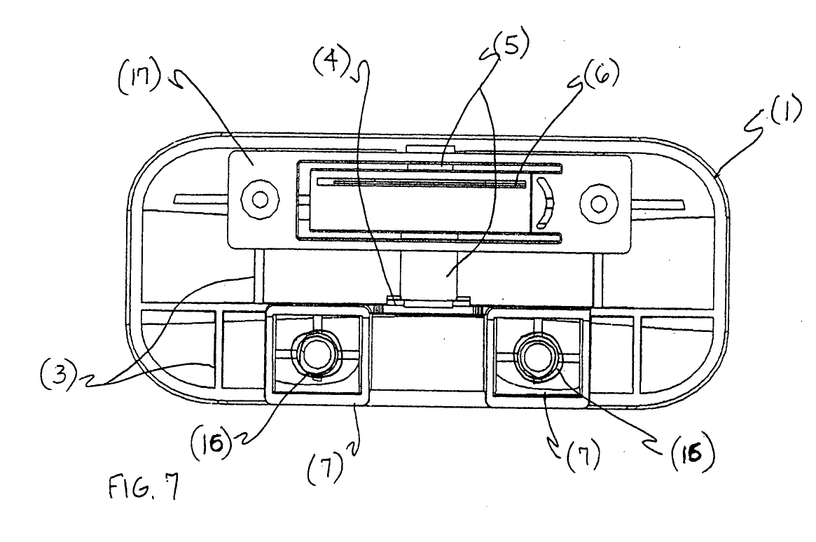

For safety, as shown in FIGS. 5 and 7, the blade guard 17 is designed to prevent the user from cutting himself with the blade when the apparatus is in the open position or being closed. The blade guard 17 may be made out of one piece that hinges when the apparatus is closed and allows the blade to engage with the material support wheel 14. The blade guard 17 may be screwed down on top of a blade assembly after the blade assembly is inserted into the top housing 1. The hinged part of the blade guard 17 has an opening 30 that allows the cutting blade 6 to go thru when the blade guard 17 is pressed up against the material support wheel 14.

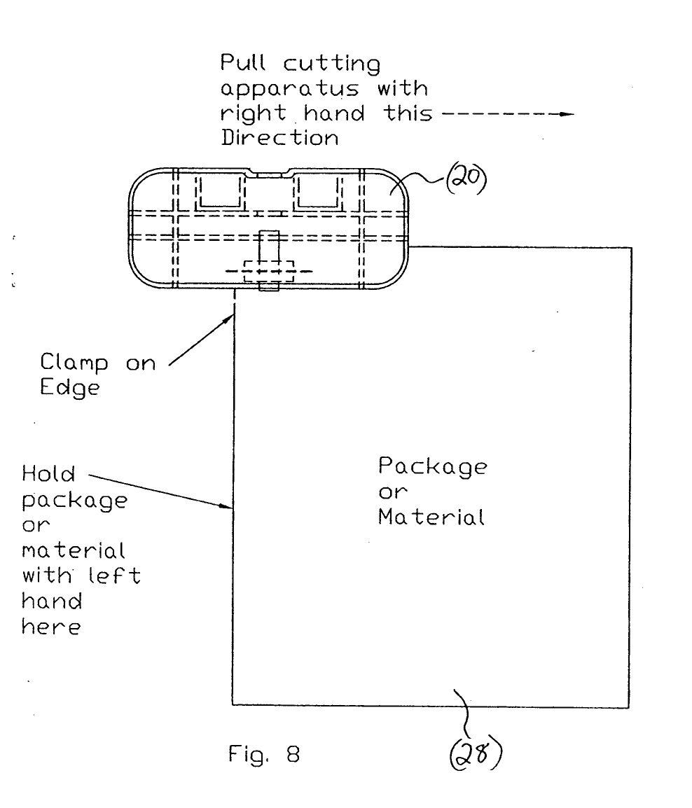

FIG. 8 illustrates the cutting apparatus 20 engaged with a package or material to be cut 28. The package or material to be cut is placed between the cutting blade 6 and cutting apparatus 20 with the cutting apparatus 20 in the open position. The user may place a portion of the package or material that is desired to be cut over the material support 14, and then close the cutting apparatus 20, so that the portion of the package or material is engaged between the cutting blade 6 and the material support 14. If the optional blade guard 17 is used, it will recede when the apparatus 20 is closed, and the cutting blade 6 will puncture the material to be cut 28. The cutting apparatus 20 is then pulled across the edge of the material or package 28 by one hand while holding the material or package in the other. The cutting blade 6 inside the apparatus 20 shears the package or material as it is pulled across the edge of the package or material completely thru to the other side, severing it from the rest of the package or material. The cutting apparatus 20 may then be opened and spread apart. The cutting apparatus 20 or the package or material 28 could be clamped down to a table or surface for two handed operation. The version represented here is a hand held version but could have a clamping mechanism added to it and should not be limited as such.

Several embodiments of the invention are specifically illustrated and/or described herein. However, it will be appreciated that modifications and variations of the invention are covered by the above teachings and within the purview of the appended claims without departing from the spirit and intended scope of the invention

What is claimed is:

1. A cutting apparatus, comprising:
a first housing including a cutting blade; and
a second housing spaced apart from the first housing, the second housing including a material support, the material support including a groove, the cutting apparatus operable to move from an open position where the cutting blade is spaced apart from the material support to a closed position where the cutting blade engages in the groove of the material support.

2. The cutting apparatus of claim 1, further comprising a blade guard positioned over the blade.

3. The cutting apparatus of claim 2, wherein the blade guard covers the blade when the cutting apparatus is in the open position, and allows the cutting blade to be exposed when the cutting apparatus is in the closed position.

4. The cutting apparatus of claim 3, wherein the blade guard is hinged and includes an opening, and when the cutting apparatus is moved to the closed position, the blade guard presses against the material support and moves to a receded position allowing exposure of the cutting blade in the groove.

5. The cutting apparatus of claim 1, wherein the second housing includes grooves for positioning of a user's hand.

6. The cutting apparatus of claim 1, wherein the material support is in the shape of a wheel.

7. The cutting apparatus of claim 6, wherein an item to be cut may be engaged between the cutting blade and the groove of the material support when the cutting apparatus is in the closed position.

8. The cutting apparatus of claim 7, wherein the material support and the cutting blade both rotate when the cutting apparatus is operated to cut the item.

9. The cutting apparatus of claim 1, wherein the cutting apparatus locks in the closed position.

10. The cutting apparatus of claim 9, wherein the first housing includes a hole, the second housing includes a spring catch button that engages with the hole to lock the cutting apparatus in the closed position, and the spring catch button is operable to disengage from the hole to release the cutting apparatus from the closed position.

11. The cutting apparatus of claim 1, further comprising a spring within the cutting apparatus to urge the cutting apparatus from the closed position to the open position.

12. A method of forming a cutting apparatus, comprising:
forming a first housing including a cutting blade; and
forming a second housing spaced apart from the first housing, the second housing including a material support, the material support including a groove, the cutting apparatus operable to move from an open position where the cutting blade is spaced apart from the material support to a closed position where the cutting blade engages in the groove of the material support.

13. The method of claim 12, further comprising forming a blade guard positioned over the blade.

14. The method of claim 13, wherein the blade guard covers the blade when the cutting apparatus is in the open position, and allows the cutting blade to be exposed when the cutting apparatus is in the closed position.

15. The method of claim 14, wherein the blade guard is hinged and includes an opening, and when the cutting apparatus is moved to the closed position, the blade guard presses against the material support and moves to a receded position allowing exposure of the cutting blade in the groove.

16. The method of claim 12, further comprising forming grooves in the second housing for positioning of a user's hand.

17. The method of claim 12, further comprising forming the material support in the shape of a wheel.

18. The method of claim 17, wherein an item to be cut may be engaged between the cutting blade and the groove of the material support when the cutting apparatus is in the closed position.

19. The method of claim 18, wherein the material support and the cutting blade both rotate when the cutting apparatus is operated to cut the item.

20. The method of claim 19, further comprising forming the first housing with a hole, forming the second housing with a spring catch button that engages with the hole to lock the cutting apparatus in the closed position, wherein the spring catch button is operable to disengage from the hole to release the cutting apparatus from the closed position.

21. The method of claim 12, further comprising forming the cutting apparatus with a spring to urge the cutting apparatus from the closed position to the open position.
